(19) United States
(12) Patent Application Publication
(10) Pub. No.: US 2011/0122243 A1
(43) Pub. Date: May 26, 2011

(54) IMAGE PROCESSING DEVICE FOR DETECTING CONTRAST TRANSITION, PARTICULARLY IN A MACHINE TOOL

(75) Inventors: Wolfgang Niehsen, Bad Salzdetfurth (DE); Thilo Koeder, Gerlingen (DE); Joachim Platzer, Remseck-Hochberg (DE)

(73) Assignee: Robert Bosch GMBH, Stuttgart (DE)

(21) Appl. No.: 12/992,212

(22) PCT Filed: Mar. 16, 2009
(86) PCT No.: PCT/EP09/53082

§ 371 Date: Feb. 3, 2011

(30) Foreign Application Priority Data
May 14, 2008 (DE) 10 2008 001 760.4

(51) Int. Cl. H04N 7/18

(52) U.S. Cl. 348/82; 348/E07.085

(57) ABSTRACT

An image processing device for detecting contrast transition comprises a digital imaging unit as an optical sensor unit, the digital sensor signals of which are processed in an evaluation unit.

The invention relates to an image processing device for detecting a contrast transition according to the generic term of claim 1.

### STATE OF THE ART

DE 10 2005 005 348 A1 describes an image processing device in a motor vehicle, with which the position of the motor vehicle in the driving lane has to be determined, whereby a warning signal is send out in case the target track is left. The image processing device comprises a video camera, which produces an analog video signal of the driving lane, which is evaluated in an evaluation unit. The evaluation unit comprises a filter with a differentiator as well as a threshold switch, whereby the video signal is undergoing a differentiation in the differentiator for the contract transition detection and the signal that is produced that way is compared in the threshold switch with a reference value. If the differentiated signal exceeds the assigned reference value a contrast transition is detected, which indicates the exceeding of a lateral road mark, upon which the warning signal is produced.

The use of the video camera provides a significant expenditure, whereby the application possibilities are correspondingly limited.

### DISCLOSURE OF THE INVENTION

The invention is based on the task to provide an inexpensive image processing device with means that can be realized simply.

This task is solved according to the invention with the characteristics of claim 1. The sub-claims provide useful improvements.

According to the invention the image processing device is used for detecting a contrast transition, whereby machine tools are a preferred application field, in particular hand-operated machine tools as for example hand-operated jigsaws. With the aid of the image processing device a target track or a target line can be detected, which the machine, which the image processing device is built in, shall follow. The target track can be a target or cutting line on the work piece that has to be processed, along which the processing with the tool of the machine tool shall take place. The preferred application takes therefore place in hand-operated machine tools, whereby generally also semi-stationary or stationary machine tools come into consideration.

Further fields of application are the use in motor vehicles, in particular for detecting the target track by detecting road marks with the aid of the image processing device. In addition to that an application in home appliances is also possible, which are equipped with a tool for processing an object, for example electric kitchen tools, whereby the image processing device detects for example the contrast between a cutting line and the bordering areas and whereby a warning signal is produced in the case of a deviation from the target track, which can be displayed and which can apart from that also be used for switching off the tool.

The image processing device for detecting contrast transitions comprises an optical sensor unit, which is implemented as digital image capture unit and which produces a line- or column-shaped digital picture in the form of digital sensor signals, which have to be supplied to a downstream evaluation unit. The sensor signals are analyzed in the evaluation unit, whereby in particular signal changes are determined, because they characterize a contrast transition in the taken picture, which serves for detecting the target track or the leaving of the target track. A digital camera comes in particular in consideration for a digital image capture unit, which can be implemented relatively simple due to its limited field of application and the task to have to transfer only contrasts. A relatively low resolution with a reduced pixel number can for example be sufficient.

Due to the low quality requirements also other digital image capture units can be used, for example optical sensors such as mouse sensors or such alike.

The evaluation unit downstream of the digital image capture unit can either be equipped for processing analog input signals or digital input signals, whereby generally an alternative and also a cumulative implementation of analog as well as digital signal processing comes into consideration.

In the case of an analog signal processing the evaluation unit comprises a digital analog converter, which can be supplied with the digital sensor signals of the image capture unit as input values and which converts the digital signals in analog signals. These can subsequently be analyzed and evaluated in the evaluation unit in the familiar way, for example in a differentiator that is assigned to the evaluation unit and downstream of the digital analog converter, in which a differentiation of the signals is carried out. By the differentiation of the signals an increase of the brightness transitions is achieved, which indicate a contrast transition. In a comparator that is also assigned to the evaluation unit subsequently a comparison of the signal that has been determined in the differentiator with a reference value can be carried out, whereby a contrast transition is detected if the brightness difference in the signal exceeds a reference value. Due to the change of this reference value the sensitivity of the evaluation can be adjusted.

In the case of the digital evaluation a digital analog converter can be waived, because the sensor signals are already present in a digital form at the output of the optical image capture unit. In that case the analysis and evaluation in the evaluation unit takes for example place by a logic gate, for example an and-gate, at which different digital signals, which origin from the image capture unit, are connected in a logical way, whereby the result of the logical connection has to correspond with a certain value or lie within a defined norm area for a contrast transition to be present. But generally also the processing of the digital signals in a microcontroller is possible as an alternative, which is for example equipped with an interrupt-on-change function. Finally the evaluation of the digitally received signals can also be carried out by a so-called edge filter, which can be a component of the evaluation unit. In each case it can be determined by the evaluation in the evaluation unit whether a contrast transition within the viewed image section that indicates a target track takes place. The sensitivity can also be adjusted at the digital evaluation thereby, in that low-order bits are masked, which can for example already be implemented n the hardware side by a corresponding configuration in the tri-state register, so that no additional computational costs are required.

Further advantages and useful embodiments shall be taken from the further claims, the description if the figures and the figures. It is shown in:

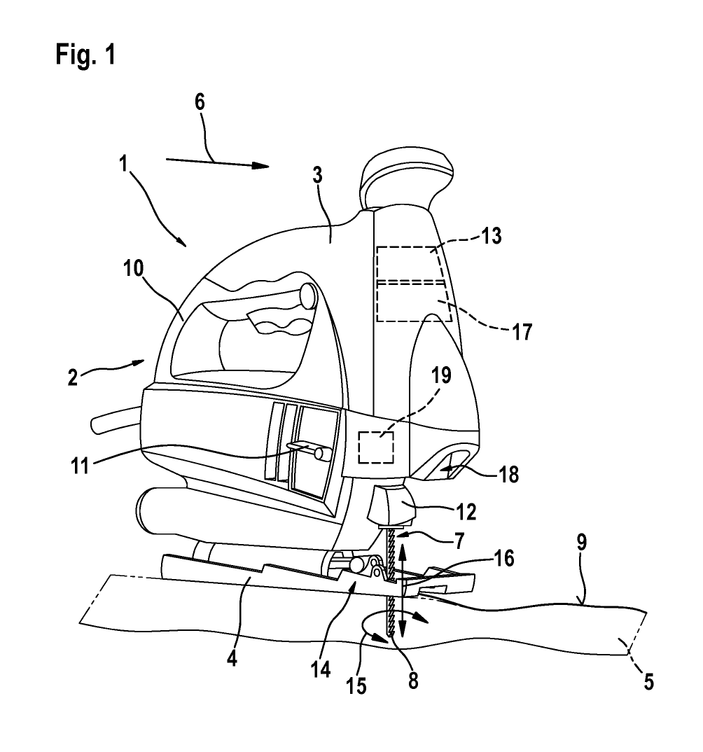

FIG. 1 a perspective illustration of a machine tool implemented as hand-operated jigsaw, which is equipped with an image processing device for detecting a target line, which the toll of the jigsaw is supposed to be following,

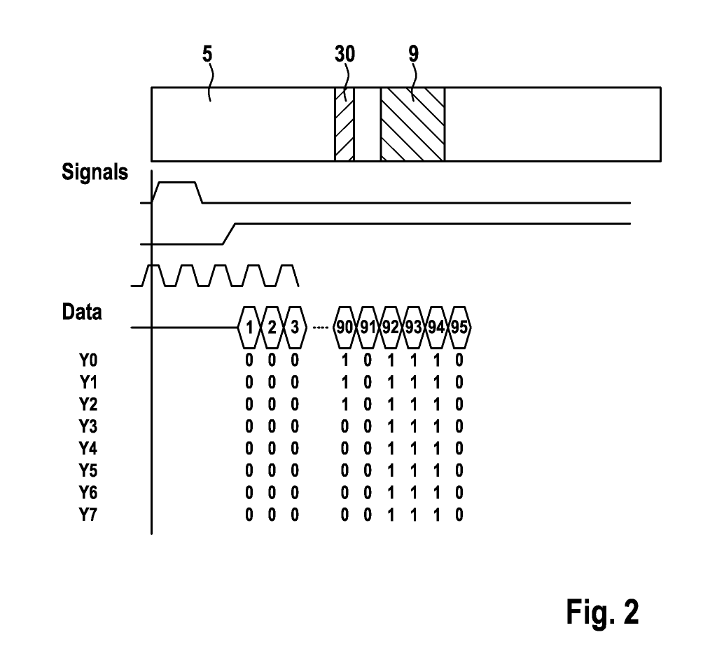

FIG. 2 a section of a driving lane in a schematic illustration with differently strong contrasts and assigned signals of the image processing device,

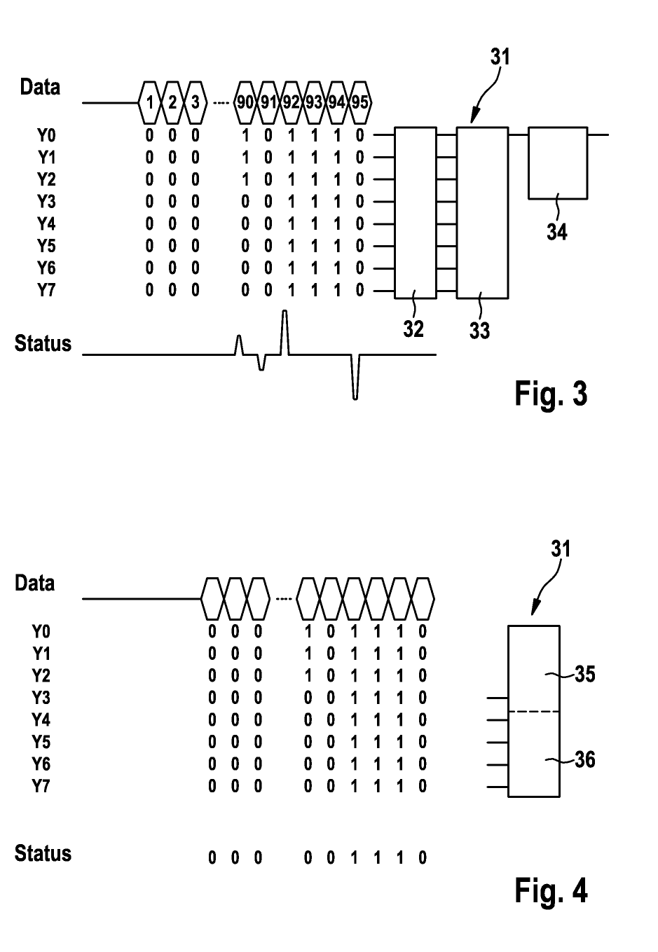

FIG. 3 the evaluation of the sensor signals that have been produced in a digital camera by an analog evaluation unit,

FIG. 4 the evaluation of the digital sensor signals in a digital evaluation unit.

The machine tool 1 shown in FIG. 1 is a hand-operated jigsaw 2, which provides an electrical drive motor in a housing 3 for the driving movement of the working tool 7 that is implemented as saw blade 8, whereby the saw blade 8 carries out a lifting movement according to arrow 16. The saw blade 8 is lead through a foot plate 4, which is connected to the housing 3 and which is put on a work piece 5 that has to be processed. The work piece 5 is provided with a marking 9, which illustrates a cutting or target line, along which the processing shall take place by a jigsaw 2. For mounting the jigsaw 2 a grip handle 10 is provided at the housing 3, the switching on and off takes place by a switch 11. The saw blade 8 is held in a machine tool slot 12.

A digital camera 18 is arranged in a front area of the housing 3, by which the working area can be detected, which lies directly in front of the saw blade 8. The advancing or working direction is indicated by arrow 6, correspondingly the area that is detected by the digital camera 18 lies in front of the saw blade 8 in the direction of the arrow 6.

The jigsaw 2 is implemented as partially automated tool and provides in addition to the electrical drive motor, which is responsible for the lifting movement of the saw blade 8, further actuators 13 and 14 for adjusting the saw blade, so that the saw blade can automatically follow the target line 9 on the work piece 5 in the range of adjusting possibilities. A first actuator 13 is located in the upper part of the housing 3 above the machine tool slot 12 and allows a rotating or pivoting of the saw blade 8 around the saw blade longitudinal axis according to arrow 15. The second actuator 14 is located in the lower part of the jigsaw 2 and allows a translational and/or rotary movement of the saw blade 8 transversely to the advancing direction 6, whereby a pendulum movement of the saw blade can be adjusted.

All actuators in the jigsaw 2, also the electrical drive motor and the two actuators 13 and 14, are adjusted by corrective signals of a regulating or control unit 17, which receives the signals of the digital camera 18 as input and produces corrective signals for impinging the drive motor or the actuators from the received signals. A closed loop is achieved by the digital camera 18 that illustrates a control unit 17, the regulating or control unit 17 as well as the actuators 13 and 14 that function as actuators as well as the drive motor.

During the operation of the jigsaw the target line 9 is detected by the digital camera 18, which is drawn on the top side of the work piece 5. The digital camera 18 creates together with the regulating or control unit 17 the image processing device for detecting contract transitions between the target line 9 and the bordering areas of the work piece 5.

Instead of a digital camera also other optical image capture units can be used, which are implemented digitally and which deliver corresponding digital signals. Such an additional digital sensor is for example listed under the reference sign 19.

FIG. 2 shows a section from the working area of the jigsaw directly in front of the saw blade. The working area is located on the top side of the work piece 5 that has to be processed, whereby the marking, which illustrates the target line for the tool, is indicated by the reference sign 9. The target line 9 provides a strong contrast as opposed to the directly surrounding areas of the work piece 5.

Additional a stripe 30 is present on the top side of the work piece 5 parallel to the target line 9, which provides a lower contrast than the target line 9 in relation to the surrounding areas of the top side of the work piece 5. The stripe 30 illustrates for example an interruption in the surface of the work piece, but it can also be a shadow or such alike. With the aid of the different contrasts of target lines 9 and stripes 30 the functioning shall be described subsequently.

The working area is recorded by the digital image capture unit, which delivers diverse signals, which are analyzed and evaluated in an evaluation unit. As it is indicated by Y0 (LSB) to Y7 (MSB) for the bit value within a line on the one hand as well as the numbers 1 to 95 for the different columns on the other hand, the digital image capture unit delivers a digital, line- and column-shaped grid, whereby each grid place is filled with the value “0” or the value “1”. “1” means thereby a detected contrast, at “0” no contrast could be detected. The target line 9 is assigned to the value “1” due to the relatively strong contrast over the entire width in all Y-values. Contrary the stripe 30 is only assigned to the value “1” in the Y-values Y0, Y1 and Y2, the remaining Y-values Y3 to Y7 have the value “0”.

FIG. 3 pictures the date set that is determined in FIG. 2, which is supplied to an analogously working evaluation unit 31. The evaluation unit 31 is in particular a component of the regulating or control unit 17 (FIG. 1).

The evaluation unit 31 according to FIG. 3 comprises a processor or a latch 32, a digital analog converter 33 as well as a differentiator 34. The digital data that is supplied to the evaluation unit 31 is converted into digital signals in the digital analog converter 33, which are subsequently undergoing a differentiation in the downstream differentiator 34. At the differentiation differences at the change of the signal course are increased, whereas constant signals deliver no output values at the differentiation. Thereby a signal course is achieved that is characterized by “status”, which provides am amplitude in the transition between the stripe 30 or the target line 9 and the directly bordering areas of the work piece top side. Because the contrast of the stripe 30 is lower than the contrast of the target line 9, correspondingly the amplitudes assigned to the stripe 30 are lower than the amplitudes assigned to the target line 9. By a comparator, which has to be supplied with the signals from the differentiator 34 and which is also part of the evaluation unit, the signals can be evaluated by determining whether the amplitude is big enough that a contrast can be detected, which is assigned to a target line. If the signal on the other hand is lower, the contrast is correspondingly lower and correspondingly it can be determined that that contrast does not belong to the target line.

FIG. 4 shows a further embodiment for an evaluation unit 31, which in contrast to FIG. 2 does not work on an analogous basis but on a digital basis. The evaluation unit 31 comprises alternatively either a logic gate 35 or a microcontroller 36. The logic gate is for example implemented as and-gate, which causes only one result “1”, if all Y-values have the value “1”. Since that cannot be the case in regard to the stripe 30, the logic gate 35 delivers the result value “0” for the stripe 30, whereas the result value “1” is delivered for the target line 9, because all Y-values of the target line also have the value “1”. By this means it can be distinguished between a sufficient contrast regarding the target line 9 and an insufficient contrast regarding the stripe 30.

In the example of a microcontroller 36 the signals are processed in a numeric way. Reference values can thereby be predefined, whereby the sensitivity has to be adjusted over the size of the reference values.

As a further possibility an embodiment of the digital camera 31 with an edge filter comes into consideration.

1. Image processing device for detecting contrast transition, in particular in a machine tool, with an optical sensor unit, whose sensor signals can be supplied to an evaluation unit, in which he signal changes for the detection of a contrast transition can be determined, wherein the optical sensor unit is implemented as a digital image capture unit, whose digital sensor signals are processed in the evaluation unit.

2. The image processing device according to claim 1 in that wherein the digital image processing device is a digital camera.

3. The image processing device according to claim 1 wherein the evaluation unit comprises a digital analog converter in which the digital sensor signals can be converted into analogous signals.

4. The image processing device according to claim 3 wherein the evaluation unit comprises a differentiator that is downstream after the digital analog converter.

5. The image processing device according to claim 4 wherein the differentiator is assigned to a comparator, with which a comparison of the signal that has been determined in the differentiator with a reference value can be carried out.

6. The image processing device according to claim 1, wherein the evaluation unit comprises a logic gate, in which the digital sensor signals have to be evaluated.

7. The image processing device according to claim 1, wherein the evaluation unit comprises a microcontroller, in which the digital sensor signals have to be evaluated.

8. The image processing device according to claim 1, wherein the evaluation unit comprises an edge filter, in which the digital sensor signals have to be evaluated.

9. The image processing device according to claim 1, wherein low-order bits are masked in an adjustable way in the evaluation unit that is assigned to the digital sensor signals.

10. Procedure for operating the image processing device according to claim 1, wherein the detection of the contrast processing transition is used for detecting a target track.
